(19) United States
(12) Patent Application Publication
(10) Pub. No.: US 2025/0224355 A1
(43) Pub. Date: Jul. 10, 2025

(54) SAMPLE CONTAINER AND THERMAL ANALYZER

(71) Applicant: HITACHI HIGH-TECH SCIENCE CORPORATION, Tokyo (JP)

(72) Inventors: Shuta NAKAGAWA, Tokyo (JP); Ryokuhei YAMAZAKI, Tokyo (JP); Hirohito FUJIWARA, Tokyo (JP)

(21) Appl. No.: 18/981,194

(22) Filed: Dec. 13, 2024

(30) Foreign Application Priority Data
Jan. 9, 2024 (JP) 2024-001125

(51) Int. Cl. G01N 25/48; G01N 5/04

(52) U.S. Cl. CPC G01N 25/486; G01N 5/04

(57) ABSTRACT

A sample container and a thermal analyzer that enable stable observation of measurement samples regardless of the surface state of the sample container in thermal analysis are proposed. The sample container is a sample container used with a thermal analyzer for measurement of thermal behavior according to a temperature variation from heating or cooling of a measurement sample and observation of the measurement sample. The sample container includes a body in a cylindrical shape having a bottom and an open top and a loading plate placed on a bottom surface inside the body on which the measurement sample is to be placed, wherein average roughness of a surface of the loading plate that faces the measurement sample is less than average roughness of the bottom surface.

### CROSS REFERENCE TO RELATED APPLICATION

The present application claims priority to Japanese Patent Applications No. JP2024-001125, filed Jan. 9, 2024, the entire contents of which are incorporated herein for all purposes by this reference.

### BACKGROUND

### 1. Technical Field

The present disclosure relates to a sample container that is used with a thermal analyzer that heats a (measurement) sample and measures physical variations including measurement of thermal weight and heat quantity of the measurement sample according to a temperature variation, and a thermal analyzer using the sample container.

### 2. Description of the Related Art

In the related art, a technique called thermal analysis that heats a sample and measures physical variations of the sample according to a temperature variation has been used as a technique of evaluating the temperature characteristic of a sample. Thermal analysis is defined in “General rules for thermal analysis” in JIS K 0129:2005 and techniques of measuring physical properties of a measurement target (sample) when the temperature of the sample is controlled by a program are all called thermal analysis. As general thermal analysis, there are five kinds of methods, (1) differential thermal analysis (TDA) that detects a temperature (temperature difference), (2) differential scanning calorimetry (DSC) that measures a heat flow difference, (3) thermogravimetry (TG) that detects mass (weight variation), (4) thermomechanical analysis (TMA) that detects dynamic characteristics, and (5) dynamic mechanical analysis (DMA).

Further, there is also a thermogravimeter-differential thermal analyzer (TG/DTA or TG/DSC) that simultaneously measures thermal weight and differential heat (e.g., see Patent Document 1).

Further, recently, there is a demand for observing the state of samples in thermal analysis, so a thermal analyzer having an opening at a furnace for heating a sample so that it is possible to observe a sample through the opening has been known. Cylindrical sample containers having a bottom and an open top, as described in Patent Document 2, are used for such observation.

### RELATED ART DOCUMENTS

### Patent Documents

[Patent Document 1] Japanese Patent Laid-Open Publication No. Hei. 8-327573
[Patent Document 2] Japanese Patent Laid-Open Publication No. JP2015-108540

### SUMMARY

However, when polishing traces or rough surfaces of a container material remain on the bottom surface of a sample container in forming of the container, the roughness of the bottom surface influences reflective light when observing a sample, so it may be difficult to observe a sample. In particular, there is a problem when a sample is transparent (translucent), the bottom surface of a sample container under the sample influences observation of the sample.

Accordingly, the present disclosure has been made in an effort to solve the problems described above and an objective of the present disclosure is to provide a sample container and a thermal analyzer that enable stable observation of a measurement sample regardless of the surface state of the sample container in thermal analysis.

In order to achieve the objectives, a sample container for a thermal analyzer is a sample container used with a thermal analyzer for measurement of thermal behavior according to a temperature variation from heating or cooling of a measurement sample and observation of the measurement sample. The sample container includes a body in a cylindrical shape having a bottom and an open top, and a loading plate placed on a bottom surface inside the body on which the measurement sample is to be placed, wherein average roughness (Ra1) of a surface of the loading plate that faces the measurement sample is less than average roughness (Ra2) of the bottom surface.

According to the sample container for a thermal analyzer, when the loading plate with roughness less than that of the bottom surface is placed on the bottom surface of the body, it is possible to stably observe the measurement sample regardless of the surface state of the bottom surface of the body without influence by the roughness of the bottom surface.

In the sample container for a thermal analyzer of the present disclosure, the measurement sample may be transparent or translucent.

When the measurement sample is transparent or translucent, the bottom surface of the sample container under the measurement sample does not influence observation of the sample, so it is possible to more stably observe the measurement sample.

In the sample container for a thermal analyzer of the present disclosure, the Ra1 may be equal to or less than 0.2 μm. According to the sample container for a thermal analyzer of the present disclosure, it is possible to surely make the surface of the loading plate smooth, so influence by the roughness of the loading plate is suppressed, and accordingly, it is possible to more stably observe measurement samples.

In the sample container for a thermal analyzer of the present disclosure, thermal conductivity of the loading plate at 25° C. is equal to thermal conductivity of the body at 25° C. with a ±10% margin of error.

According to the sample container for a thermal analyzer, the degrees of thermal conductivity of the loading plate and the body become the same in heating and cooling for measurement through the thermal analyzer, so it is possible to more stably observe measurement samples.

In the sample container for a thermal analyzer of the present disclosure, the loading plate and the body may be made of an identical material.

According to the sample container for a thermal analyzer, when the loading plate and the body are made of the identical material, thermal conductivity of them becomes the same.

A thermal analyzer includes the sample container for a thermal analyzer, a furnace surrounding the sample container and having an observation opening, and an imaging unit that enables observation of the measurement sample through the observation opening, wherein the thermal analyzer measures thermal behavior of the measurement sample according to a temperature variation in the furnace.

The thermal analyzer of the present disclosure may be a differential thermal analyzer, a differential scanning calorimeter, or a thermogravimetric apparatus.

The thermal analyzer may further include an image processing unit configured to generate predetermined color information from image data of the measurement sample obtained through the imaging unit, and may superimpose the color information and the thermal behavior with respect to temperature.

According to the present disclosure, it is possible to achieve a sample container and a thermal analyzer that enable stable observation of measurement samples regardless of the surface state of the sample container in thermal analysis.

### BRIEF DESCRIPTION OF THE DRAWINGS

FIG. 1 is a cross-sectional view showing the configuration of a thermal analyzer according to an embodiment of the present disclosure;

FIG. 2 is a perspective view showing the configuration of a sample container according to an embodiment of the present disclosure;

FIG. 3 is an axial cross-sectional view of the sample container;

FIG. 4 is a view showing a bending portion of the sample container; and

FIG. 5 is a flowchart illustrating the operation of a thermal analyzer using a sample container of the present disclosure.

### DETAILED DESCRIPTION

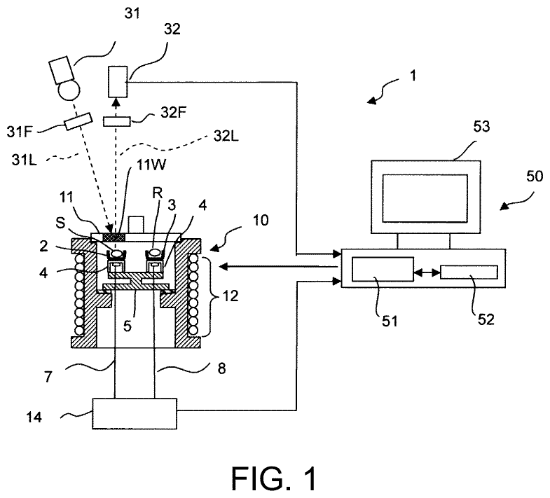

Hereinafter, embodiments of the present disclosure are described with reference to drawings. FIG. 1 is a cross-sectional view showing the configuration of a thermal analyzer according to an embodiment of the present disclosure.

A thermal analyzer 1 is a differential scanning calorimeter (DSC) and has the same configuration as differential scanning calorimeters of the related art except that a window 11W through which it is possible to observe the inside of a lid 11 of a furnace 10 is provided, so the summary is described.

The thermal analyzer 1 includes: a measurement sample container 2 that accommodates a measurement sample S; a reference substance container 3 that accommodates a reference substance R; a furnace 10; thermistors 4 that are connected between the measurement sample container 2, the reference substance container 3, and the furnace 10 and form heat flow paths therebetween; a measurement sample-side thermocouple 7; a reference substance-side thermocouple 8; a light source 31 that is a lighting unit for emitting visible light to at least the measurement sample S such as an LED; a CCD camera 32 that is an imaging unit for photographing at least the measurement sample S; and a personal computer 50.

A heater 12 like wound wires is wound around the outer side of the furnace 10 and heats the furnace 10. The outer side of the heater 12 is covered with a cover (not shown).

The CCD camera 32, for example, is an area scan type, but may be a line scan type and other solid-state image sensing devices such as a CMOS camera may be used.

The personal computer 50 includes a Central Processing Unit (CPU) 51, a storage unit 52 such as a hard disk, a display 53 such as a liquid crystal monitor, a keyboard or a mouse (not shown), etc.

The furnace 10 is in a cylindrical shape and has an H-shaped axial cross-section. A substantially double disc-type thermal plate 5 is placed on a ring-shaped protrusion protruding inward in the diameter direction from the axial center.

The measurement sample container 2 and the reference substance container 3 are placed on the top of the thermal plate 5 with two thermistors 4 therebetween, respectively, and the measurement sample container 2 and the reference substance container 3 are accommodated in an internal space surrounded by the furnace 10.

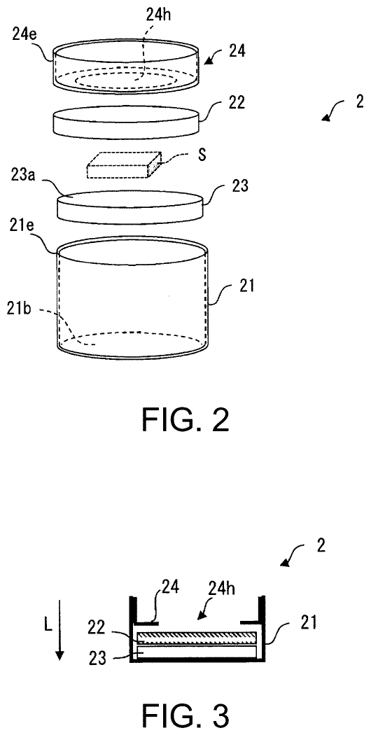

A measurement sample S is accommodated in the measurement sample container 2, a pressing plate 22 is placed on the top of the measurement sample S, and a loading plate 23 is disposed between the bottom surface of the measurement sample container 2 and the measurement sample S (FIG. 2). The pressing plate 22 is made of a material that is transparent or translucent and transmits visible light with predetermined light transmittance. As the transparent (translucent) material, silica glass, sapphire glass, yttrium-aluminum-garnet (YAG) ceramic, Tempax, Neoceram (registered trademark), Vycor (registered trademark), and Pyrex (registered trademark) may be appropriately used.

Meanwhile, a pressing plate the same as that of the measurement sample container may also be placed on the reference substance R in the reference substance container 3 retaining the reference substance R so that the measurement sample S and the reference substance R are surely heated under the same condition in the furnace 10. The pressing plate 22 is not a necessary component in the present disclosure. When the pressing plate 22 is used, it has only to be used for at least the measurement sample container 2.

However, it is preferable to place the same pressing plate as that of the measurement sample container on the reference substance R in the reference substance container 3.

The measurement sample-side thermocouple 7 and the reference substance-side thermocouple 8 pass through the thermistors 4 and the thermal plate 5 and first ends thereof are connected to the bottoms of the measurement sample container 2 and the reference substance container 3, respectively, by soldering. Meanwhile, second ends of the measurement sample-side thermocouple 7 and the reference substance-side thermocouple 8 are drawn downward out of the furnace 10 and are connected to an amplifier 14 constituting a signal processing circuit.

Accordingly, the measurement sample-side thermocouple 7 and the reference substance-side thermocouple 8 form so-called differential thermocouples and make it possible to detect a temperature difference of the measurement sample S and the reference substance R. This temperature difference is recorded as a heat flow difference signal. Meanwhile, the temperature of a measurement sample is recorded from the measurement sample-side thermocouple 7.

The temperature of the furnace 10 is input to the CPU 51 through various control circuits and the CPU 51 controls application of electricity to the heater 12, whereby the furnace 10 is controlled to be heated or cooled at a predetermined rate.

The lid 11 is detachably placed over the opening at the upper end of the furnace 10, thereby isolating the inside of the furnace 10 from the external air.

A window 11W made of silica glass is disposed at the portion of the lid 11 that overlaps the measurement sample container 2 in the axial direction of the furnace 10 and the CCD camera 32 is disposed over the window 11W.

A light source 31 for lighting the measurement sample S in the furnace 10 through the window 11W is disposed above the window 11W on a line different from the axial line of the CCD camera 32.

Incident light (visible light) 31L is emitted to the measurement sample S from the light source 31 and the CCD camera 32 obtains luminance or intensity of reflective light 32L from the measurement sample S.

Filters 31F and 32F are disposed between the window 11W and the light source 31 and between the window 11W and the CCD camera 32, respectively, so only light with a specific component is emitted to the window 11W and only reflective light with a specific component is sent to the CCD camera 32. However, the filters 31F and 32F are not essential. In a coaxial episcopic illumination (half mirror type), the optical axis of the light source 31 of emitted light and the optical axis of the camera 32 are aligned.

Next, the sample container according to an embodiment of the present disclosure is described by exemplifying the measurement sample container 2. FIG. 2 is a perspective view showing the configuration of the measurement sample container 2 and FIG. 3 is a cross-sectional view of the measurement sample container 2 cut in the axial direction L.

The measurement sample container 2 includes a body 21 in a cylindrical shape having a bottom and an open top, a pressing plate 22, a loading plate 23, and a lid 24, in which the pressing plate 22, the loading plate 23, and the lid 24 are formed substantially in disc shapes having a diameter the same as or slightly smaller than the inner diameter of the body 21.

The pressing plate 22 is transparent or translucent, as described above, and presses a measurement sample S placed on the bottom surface of the body 21 from the top.

The body 21, the loading plate 23, and the lid 24, for example, are made of aluminum (alloy).

The pressing plate 22 and the lid 24 are not essential components in the present disclosure.

The loading plate 23 is placed on the bottom surface 21b inside the body 21 and is provided for placing a measurement sample S thereon.

Average roughness Ra1 of the surface (top) 321 of the loading plate 23 that faces the measurement sample S is less than average roughness Ra2 of the bottom surface 21b.

The average roughness Ra1 and Ra2 may be the arithmetic mean roughness defined in JIS-B0601:2013.

When polishing traces or rough surfaces of the material of the body 21 remain on the bottom surface 21b inside the body 21 in forming of the body 21, the roughness of the bottom surface 21b influences reflective light when observing a sample, particularly, when the measurement sample is transparent (translucent), so it may be difficult to observe the sample.

Accordingly, when the loading plate 23 with smaller roughness than the bottom surface 21b is placed on the bottom surface 21b, as shown in FIG. 3, incident light 31L that has passed through a measurement sample S reflects from the surface of the loading plate 23 and becomes reflective light 32L, so it is possible to stably observe the measurement sample regardless of the surface state of the bottom surface 21b of the body 21 without influence by the roughness of the bottom surface 21b.

When Ra1 is less than 0.2 μm, it is possible to surely make the surface of the loading plate 23 smooth, so influence by the roughness of the loading plate 23 is suppressed, and accordingly, it is possible to more stably observe measurement samples.

When the thermal expansion coefficient of the loading plate 23 at 25° C. is equal to the thermal expansion coefficient of the body 21 at 25° C. with a ±10% margin of error, the degrees of thermal expansion of the loading plate 23 and the body 21 become the same in heating and cooling for measurement through the thermal analyzer, so it is possible to more stably observe measurement samples.

In particular, when the loading plate 23 and the body 21 are made of an identical material, the thermal expansion coefficients of them become the same, which is preferable.

In this embodiment, the pressing plate 22 is placed on the top of a measurement sample S and presses the measurement sample S from the top. Accordingly, since the pressing plate 22 presses the measurement sample S, deformation of the measurement sample S from heating or cooling for measurement through the thermal analyzer is suppressed and it is possible to more stably observe the measurement sample.

In this embodiment, the lid 24 is placed on the top of the pressing plate 22. The lid 24 has one hole 24h formed at the center to observe measurement samples. The (outer) circumferential edge 24e of the lid 24 vertically protrudes upward, thereby forming a flange.

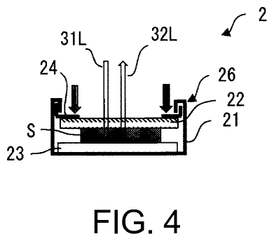

As shown in FIG. 4, at least portions of an opening edge 21e of the body 21 and the outer circumferential edge (flange) 24e of the lid 24 are both bent downward (throughout the circumference in this embodiment) with a measurement sample S disposed between the bottom surface of the body 21 and the pressing plate 22, whereby a bending portion 26 is formed.

Since the bending portion 26 is formed, the lid 24 is pressed downward (toward the pressing plate 22). Accordingly, the pressing plate 22 presses a measurement sample S through the lid 24, whereby the measurement sample S is more sufficiently pressed and deformation of the measurement sample S or the pressing plate 22 can be further suppressed.

The opening edge 21e of the body 21 (the side in this embodiment) and the circumferential edge (flange) 24e of the lid 24 need to be substantially parallel and the lid 24 needs to have a flange so that bending is possible.

As long as the opening end 21e and the circumferential edge (flange) 24e are bending portions, they may be seams that are used for manufacturing cans, etc.

The entire of the opening end 21e and the circumferential edge (flange) 24e may be bent, but only a portion (e.g., four portions with regular intervals in the circumferential direction) of the circumferential edge may be bent as long as the measurement sample S is sufficiently pressed.

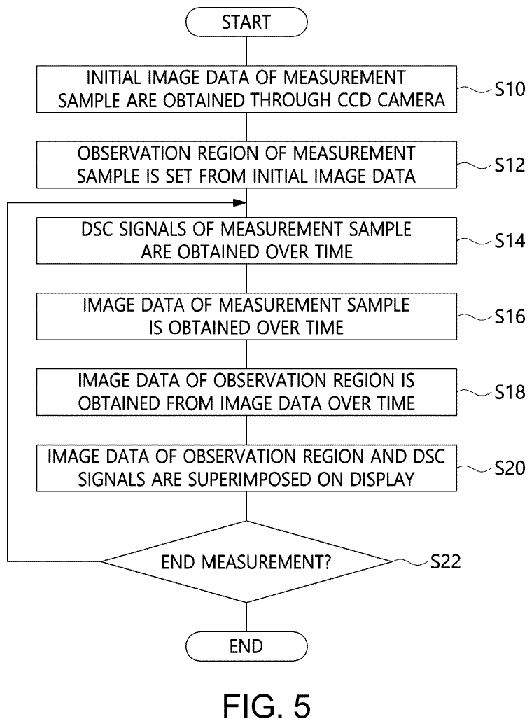

Next, the operation of a sample container and a thermal analyzer using the sample container is described with reference to the flowchart of FIG. 5.

First, visible light is emitted to a measurement sample S by the light source 31 and initial image data of the measurement sample S is obtained at the CPU 51 of the personal computer 50 using the CCD camera 32 (step S10).

Next, the image data is displayed on the display 53 of the personal computer 50 and a user sets the location information of an analysis region in the image of the measurement sample S on the display 53 using a mouse, a keyboard (not shown), or the like (step S12).

The location information may be one point or may be a region having an area following an outer edge. When one point is determined, a circle, etc. having a predetermined radius or a predetermined area around the point may be considered as a virtual region.

Heat flow difference signals (DSC signals) are obtained over time while heating or cooling the measurement sample S through the heater 12 or a cooling part (not shown) (step S14).

The processing of step S14 is the same as processing that is performed by a differential scanning calorimeter (DSC) of the related art, the measurement sample S itself is heated or cooled, and corresponding differential scanning calories (DSC) are measured.

In the present disclosure, DSC signals are obtained with respect to any one variable of time or temperature. In common differential scanning calorimeters, the heating or cooling rate is constant and time and temperature are related to each other.

The CCD camera 32 obtains image data of the image of the measurement sample S over time and outputs the image data to the CPU 51 (step S16).

When image data is obtained in step S16, the same variable as the variable (time in this embodiment) used for obtaining heat flow difference signals (DSC signals) in step S14 may be used, but other variables may be used.

Next, image data corresponding to the location information of the measurement sample S set in step S12 is obtained from the image data over time in step S16 by the CPU 51 (step S18).

The image data is stored in the storage unit 52.

When the measurement sample S is a region having an area, the average value of the luminance or intensity of the pixels of the image data in the region is employed.

The image data of the measurement sample S obtained in step S18 and the heat flow difference signals (DSC signal) of the measurement sample S obtained in step S14 are superimposed on each other on the display 53 (step S20).

Next, the user determines whether it is required to end measurement, and ends measurement when it is required (YES), and returns to step S14 when it is not required (NO) (step S22).

When determining whether it is required to end measurement in step S22, for example, it may be possible to determine that it is required to end measurement by setting in advance the maximum temperature or the minimum temperature for heating or cooling the measurement sample as end temperature, but the present disclosure is not specifically limited.

Visible light is emitted from a light source in the embodiment described above, but electromagnetic waves such as X-rays, infrared light, and ultraviolet light other than visible light may be emitted and the reflective light may be detected through a detector such as an X-ray detector other than a CCD camera.

It may be possible to use color variation to obtain an image of a measurement sample S. In terms of the color, information that quantifies colors may be used in addition to luminance of specific wavelengths. As the numeric information, there are Lab (L*a*b*) values of CIE (International Commission on Illumination) 1976 color space, RGB values expressing colors using combinations of red, green, and blue called ‘three primary colors of light’, CMYK values expressing colors using combinations of cyan, magenta, and yellow, which are called ‘three primary colors’, and black, etc., but the present disclosure is not limited thereto. For example, XYZ values of CIE 1931 color space, L*u*v values of CIE 1976 color space, CIECAM02, etc. may be used.

The present disclosure is not limited to the embodiments described above and covers even various modifications and equivalents included in the spirit and scope of the present disclosure.

For example, the shapes of the sample container, the body, and the loading plate are not limited to the examples described above. For example, the sample container is not limited to a cylinder and may be a polygonal cylinder or an elliptical cylinder.

The thermal analyzer of the present disclosure, which measures the physical properties of samples when the temperature of the measurement targets (samples) is controlled through programs, can be applied to a thermal analyzer having the function of differential scanning calorimetry (DSC) that detects a heat flow difference, other than the above-mentioned thermogravimeter-differential thermal analyzer (TG/DTA) defined in “General rules for thermal analysis” in JIS K 0129:2005, and can also be applied to a differential thermal analyzer (TDA) and a thermogravimeter (TG).

What is claimed is:

1. A sample container used with a thermal analyzer for measurement of thermal behavior according to a temperature variation from heating or cooling of a measurement sample and observation of the measurement sample, the sample container comprising:
a body in a cylindrical shape having a bottom and an open top; and
a loading plate placed on a bottom surface inside the body on which the measurement sample is to be placed,
wherein average roughness (Ra1) of a surface of the loading plate that faces the measurement sample is less than average roughness (Ra2) of the bottom surface.

2. The sample container according to claim 1, wherein the measurement sample is transparent or translucent.

3. The sample container according to claim 1, wherein the Ra1 is arithmetic mean roughness defined in JIS-B0601:2013 and is equal to or less than 0.2 μm.

4. The sample container according to claim 1, wherein thermal conductivity of the loading plate at 25° C. is equal to thermal conductivity of the body at 25° C. with a ±10% margin of error.

5. The sample container according to claim 2, wherein thermal conductivity of the loading plate at 25° C. is equal to thermal conductivity of the body at 25° C. with a ±10% margin of error.

6. The sample container according to claim 3, wherein the loading plate and the body are made of an identical material.

7. A thermal analyzer, comprising the sample container for a thermal analyzer according to claim 1, a furnace surrounding the sample container and having an observation opening, and an imaging unit that enables observation of the measurement sample through the observation opening,
wherein the thermal analyzer measures thermal behavior of the measurement sample according to a temperature variation in the furnace.

8. A thermal analyzer, comprising the sample container for a thermal analyzer according to claim 2, a furnace surrounding the sample container and having an observation opening, and an imaging unit that enables observation of the measurement sample through the observation opening,
wherein the thermal analyzer measures thermal behavior of the measurement sample according to a temperature variation in the furnace.

9. The thermal analyzer according to claim 7, wherein the thermal analyzer is a differential thermal analyzer, a differential scanning calorimeter, or a thermogravimetric apparatus.

10. The thermal analyzer according to claim 8, wherein the thermal analyzer is a differential thermal analyzer, a differential scanning calorimeter, or a thermogravimetric apparatus.

11. The thermal analyzer according to claim 7, further comprising an image processing unit configured to generate predetermined color information from image data of the measurement sample obtained through the imaging unit,
wherein the color information and the thermal behavior are displayed superimposed with respect to temperature.

12. The thermal analyzer according to claim 8, further comprising an image processing unit configured to generate predetermined color information from image data of the measurement sample obtained through the imaging unit,
wherein the color information and the thermal behavior are displayed superimposed with respect to temperature.
